(19) United States
(12) Patent Application Publication
(10) Pub. No.: US 2013/0187093 A1
(43) Pub. Date: Jul. 25, 2013

(54) CORE-SHELL PHOSPHOR PRODUCED BY HEAT-TREATING A PRECURSOR IN THE PRESENCE OF LITHIUM TETRABORATE

(71) Applicants: Valérie Buissette, Paris (FR); Thierry Le-Mercier, Rosny-Sous-Bois (FR)

(72) Inventors: Valérie Buissette, Paris (FR); Thierry Le-Mercier, Rosny-Sous-Bois (FR)

(73) Assignee: RHODIA OPERATIONS, Aubervilliers (FR)

(21) Appl. No.: 13/582,685

(22) PCT Filed: Feb. 28, 2011
(86) PCT No.: PCT/EP2011/052896

§ 371 Date: Nov. 16, 2012

(30) Foreign Application Priority Data
Mar. 1, 2010 (FR) 10/00819

(51) Int. Cl. C09K 11/77

(52) U.S. Cl. CPC C09K 11/7777
USPC 252/301.4 P

(57) ABSTRACT

A method of producing a phosphor is described in which a precursor including particles having an average diameter from 1.5 micrometers to 15 micrometers is heat-treated under a reducing atmosphere. The method can produce particles including a mineral core and a shell including a composite phosphate of lanthanum and/or cerium, optionally doped with terbium. The composite phosphate of lanthanum and/or cerium covers the mineral core uniformly over a thickness greater than or equal to 300 nm. The aforementioned heat treatment at a temperature of 1050° C. to 1150° C. and for a time period of 2 hours to 4 hours can involve the use of lithium tetraborate (Li₂B₄O₇), which serves as a fluxing agent, in a mass quantity of at most 0.2%.

The present invention relates to a core-shell phosphor which is capable of being obtained by heat treating a precursor in the presence of lithium tetraborate as fluxing agent.

Mixed phosphates of lanthanum, cerium and terbium are well known for their luminescence properties. They emit a bright green light when they are irradiated by certain core-energy radiation having wavelengths shorter than those in the visible range (UV or VUV radiation for lighting or display systems). Phosphors that exploit this property are commonly used on an industrial scale, for example in trichromatic fluorescent lamps, in backlighting systems for liquid crystal displays or in plasma systems.

These phosphors contain rare earths, the cost of which is high and is also subject to large fluctuations. Reducing the cost of these phosphors therefore constitutes a major challenge.

In addition, due to the rarity of certain rare earths, such as terbium, it is sought to reduce the amount thereof in phosphors.

WO 2008/012266 describes products of core-shell type that fulfil this cost reduction requirement. These products are obtained by heat treating precursors previously prepared by a wet process.

It is known that the luminescence properties of phosphors are a function of their crystallinity. Thus, better crystallized products generally have better properties, in particular a better brightness than products of the same compositions but that are less well crystallized. The degree of crystallization depends on the temperature at which the heat treatment is carried out on passing from the precursor to the phosphor.

High temperatures favor a better crystallization but in this case there may be a risk of sintering of the precursor resulting in a phosphor of which the size of the particles may be significantly larger than those of the initial precursor. In this case, and especially when products of low particle size are desired, it may be necessary to mill the phosphor resulting from the heat treatment. Such milling, if it is too intense, risks inducing surface defects on the particles of the phosphor which may have a negative influence on the luminescence properties.

There is therefore a need for phosphors of reduced cost and that have further improved luminescence properties.

The objective of the invention is to propose a phosphor that meets this requirement.

With this given aim, the phosphor of the invention is a phosphor of the type formed of particles comprising a mineral core and a shell based on a mixed phosphate of lanthanum and/or cerium, optionally doped with terbium, homogeneously covering the mineral core over a thickness greater than or equal to 300 nm, and it is characterized in that it is capable of being obtained by a method wherein a precursor comprising particles having an average diameter between 1.5 and 15 microns is heat-treated under a reducing atmosphere, these particles comprising a mineral core and a shell based on a mixed phosphate of lanthanum and/or cerium, optionally doped with terbium, homogeneously covering the mineral core over a thickness greater than or equal to 300 nm, the heat treatment taking place in the presence, as fluxing agent, of lithium tetraborate (Li₂B₄O₇) in an amount by weight of at most 0.2%, at a temperature between 1050° C. and 1150° C. and over a duration of between 2 hours and 4 hours.

Other features, details and advantages of the invention will become even more fully apparent on reading the following description and also from the appended drawings in which:

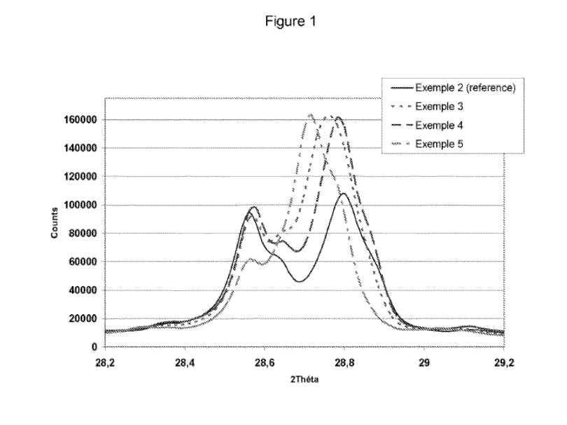

FIG. 1 is an X-ray diffractogram of comparative phosphors and of a phosphor according to the invention;

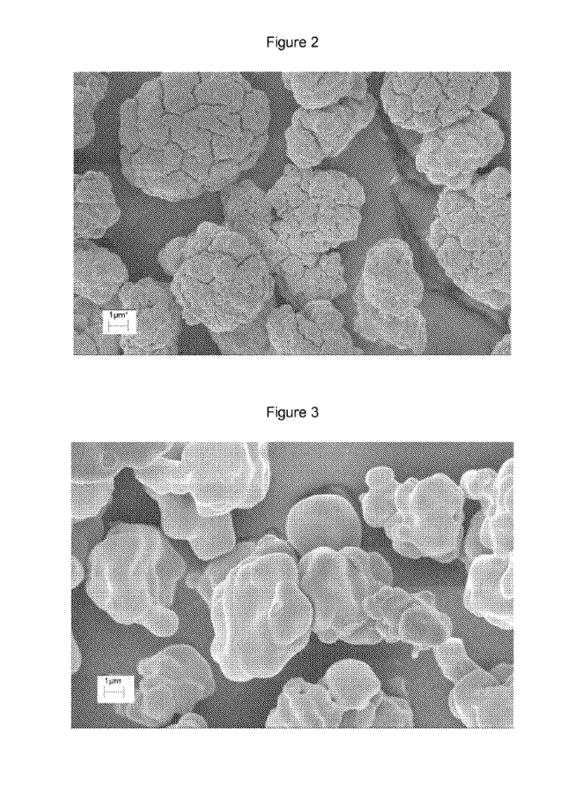

FIG. 2 is an image obtained by scanning electron microscopy (SEM) of particles of a phosphor according to the prior art;

FIG. 3 is an image obtained by SEM of particles of a phosphor according to the invention.

It is also specified that, for the remainder of the description, unless otherwise indicated, in all the ranges or fields of values that are given, the values are included to the limits, the ranges or fields of value thus defined therefore covering any value at least equal to and greater than the lower limit and/or at most equal to or less than the upper limit.

For the present description, the expression “rare earth” is understood to mean the elements from the group constituted by yttrium and the elements from the Periodic Table having an atomic number between 57 and 71 inclusive.

The expression “specific surface area” is understood to mean the B.E.T. specific surface area determined by nitrogen adsorption in accordance with the standard ASTM D 3663-78 established from the BRUNAUER-EMMETT-TELLER method described in the periodical “The Journal of the American Society, 60, 309 (1938)”.

The phosphor of the invention has improved luminescence properties which are the consequence of its preparation method.

It will be noted here that the invention therefore relates to a method for preparing a phosphor and also, as novel product, the phosphor capable of being obtained by this method. Therefore, everything which is described for the method also applies for the description of the features of the product capable of being obtained by said method.

This preparation method will be described in detail below.

One of the main features of the method of the invention is using a specific precursor as starting product.

Various embodiments of this precursor may be described.

### THE PRECURSOR ACCORDING TO A FIRST EMBODIMENT

The precursor according to this first embodiment is that which is described in WO 2008/012266. Therefore, as regards the features of this precursor, reference may be made to the whole of the description of this document.

The main features of this precursor, which is in the form of particles comprising a mineral core and a shell based on a mixed phosphate of lanthanum and/or cerium, optionally doped with terbium, will be mentioned below.

Generally, the core has an average diameter of 0.5 to 15 microns, for example 0.5 to 14 microns, typically of the order of 1 to 10 microns, in particular between 2 and 9 microns.

The mineral core of the precursor particles is advantageously based on a phosphate or on a mineral oxide.

The expression “based on” is understood to denote a core comprising at least 50%, preferably at least 70%, and more preferably at least 80%, or even 90% by weight of the material in question. According to one particular embodiment, the core may be essentially formed of said material (namely having a content of at least 95% by weight, for example at least 98%, or even at least 99% by weight).

Among the phosphates, mention may be made of phosphates, especially orthophosphates, of rare earths such as lanthanum, lanthanum and cerium, yttrium, gadolinium or a mixed phosphate thereof and also polyphosphates of rare earths or of aluminum.

Mention may also be made of alkaline earth metal phosphates such as Ca₂P₂O₇, zirconium phosphate ZrP₂O₇, and alkaline-earth metal hydroxyapatites.

Among the oxides, mention may in particular be made of the oxides of zirconium, zinc, titanium, silicon, aluminum and rare earths (especially Y₂O₃, Gd₂O₃ and CeO₂).

Furthermore, other mineral compounds may also be suitable such as vanadates (YVO₄), germanates, silica, silicates, especially zinc silicate or zirconium silicate, tungstates, molybdates, alkaline-earth metal aluminates, optionally doped with a rare earth, for instance barium and/or magnesium aluminates, such as MgAl₂O₄, BaAl₂O₄ or BaMgAl₁₀O₁₇, sulfates (for example BaSO₄), borates (for example YBO₃, GdBO₃), carbonates and titanates (such as BaTiO₃).

Finally, compounds resulting from the preceding compounds such as mixed oxides, especially of rare earths, for example mixed oxides of zirconium and cerium, mixed phosphates, especially of rare earths and phosphovanadates may be suitable.

In particular, the material of the core may have particular optical properties, especially UV radiation reflective properties.

According to one particular embodiment, the core is based on a rare earth phosphate, such as undoped lanthanum phosphate, or an aluminum oxide.

According to one specific embodiment, the mineral core of the precursor particles is essentially formed of lanthanum phosphate LaPO₄.

The core may be made of a dense material which corresponds in fact to a generally well-crystallized material or else to a material having a low specific surface area.

The expression “low specific surface area” is understood to mean a specific surface area of at most 5 m²/g, more particularly of at most 2 m²/g, more particularly still of at most 1 m²/g, and especially of at most 0.6 m²/g.

The core may also be based on a temperature-stable material. By this is meant a material which has a melting point at a high temperature, which does not degrade into a by-product which would be problematic for the application as a phosphor at this same temperature, and which remains crystalline and which is therefore not converted into an amorphous material, again at this same temperature. The high temperature intended here is a temperature at least above 900° C., preferably at least above 1000° C. and more preferably still at least 1200° C.

One possibility consists in using, for the core, a material which combines the preceding features, that is to say a temperature-stable material having a low specific surface area.

At the surface of the mineral core, the precursor comprises a layer based on a mixed phosphate (LAP) of lanthanum and/or cerium, optionally doped with terbium, having an average thickness generally of at least 0.3 micron. The thickness of the layer may more particularly be at least 500 nm. It may be less than or equal to 2000 nm (2 μm), more particularly less than or equal to 1000 nm.

This thickness may especially be between 0.3 and 1 micron, more particularly between 0.5 and 0.8 micron.

The dimensions of the core and of the shell of the precursor may be measured in particular on SEM photographs of sections of the particles. This also applies to the precursors according to the other embodiments which will be described further on.

In the precursor particles, the phosphate (LAP) is present in the form of a homogeneous layer. The expression “homogeneous layer” is understood to mean a continuous layer, completely covering the core and the thickness of which is preferably never less than 300 nm. This homogeneity of the distribution of the mixed phosphate is especially visible on scanning electron micrographs. X-ray diffraction (XRD) measurements demonstrate the presence of two separate compositions of the core and the shell.

The phosphate (LAP) which is present in the shell of the precursor particles may correspond to the general formula (I) below:

La_{(1-x-y)}CeₓTb_{y}PO₄ (I)

wherein:
x, optionally zero, is between 0 and 0.95 inclusive;
y is between 0.05 and 0.3 inclusive; and
the sum (x+y) is less than or equal to 1.

As a general rule, it is preferred that the sum (x+y) remains strictly below 1, that is to say that the compound of formula (I) contains some lanthanum. It is not however excluded that this sum could be equal to 1, in which case the compound (I) is a mixed phosphate of cerium and terbium, free from lanthanum.

According to one particularly advantageous embodiment, the mixed phosphate that is present on the outer layer of the precursor particles is a cerium LAP which corresponds to the formula (Ia) below:

La_{(1-x-y)}CeₓTb_{y}PO₄ (Ia)
wherein:
x is between 0.1 and 0.5 inclusive;
y is between 0.1 and 0.3 inclusive; and
the sum (x+y) is between 0.4 and 0.6.

According to another conceivable embodiment, the mixed phosphate that is present on the outer layer of the precursor particles is a cerium-free LAP which corresponds to the formula (Ib) below:

La_{(1-y)}Tb_{y}PO₄ (Ib)
wherein:
y is between 0.05 and 0.3 inclusive.

According to yet another conceivable embodiment, the mixed phosphate present on the outer layer of the precursor particles is a terbium-free LAP which corresponds to the formula (Ic) below:

La_{(1-y)}Ce_{y}PO₄ (Ic)
wherein:
y is between 0.01 and 0.3 inclusive.

It should be noted that the layer may comprise, besides the mixed phosphates described above, other compounds, for example polyphosphates of rare earths, generally in a minor amount that does not exceed 5% for example.

The phosphate of the shell may comprise other elements conventionally acting, in particular, as a promoter in respect of the luminescence properties or as a stabilizer for stabilizing the oxidation state of the elements cerium and terbium. As examples of other such elements, mention may more particularly be made of boron and other rare earths, such as scandium, yttrium, lutetium and gadolinium. When lanthanum is present, the aforementioned rare earths may be more particularly present as substitution for this element. These promoter or stabilizer elements are present in an amount generally of at most 1% by weight of element relative to the total weight of phosphate of the shell in the case of boron and generally at most 30% in the case of the other elements mentioned above.

It should be emphasized that, usually, in the precursor particles, approximately all the mixed LAP phosphate present is located in the layer surrounding the core.

The precursor particles have, furthermore, an overall average diameter between 1.5 and 15 microns, for example between 3 and 8 microns, more particularly between 3 and 6 microns or between 4 and 8 microns.

Moreover, the precursor particles advantageously have a low dispersion index, this dispersion index generally being less than 0.6, preferably at most 0.5, more particularly less than 0.4.

The average diameter to which reference is made is the average, by volume, of the diameters of a population of particles.

The particle size values given here and for the rest of the description are measured by means of a laser particle size analyzer, especially of the Coulter or Malvern laser type.

The term “dispersion index” for a population of particles is understood to mean, within the context of the present description, the ratio o/m as defined below:

σ/m=(Ø₈₄−Ø₁₆)/(2×Ø₅₀),
where: Ø₈₄ is the diameter of the particles for which 84% of the particles have a diameter below Ø₈₄;
Ø₁₆ is the diameter of the particles for which 84% of the particles have a diameter below Ø₁₆; and
Ø₅₀ is the diameter of the particles for which 50% of the particles have a diameter below Ø₅₀.

The precursor of this first embodiment may be prepared by the method described in WO 2008/012266.

### THE PRECURSOR ACCORDING TO A SECOND EMBODIMENT

According to another particular embodiment of the invention, the precursor is in the form of particles comprising a mineral core and a shell based on a mixed phosphate of lanthanum, cerium and terbium, these particles having an average diameter between 3 and 6 μm, more particularly between 3 μm and 5 μm, and the phosphate of lanthanum, cerium and terbium corresponding to the general formula (II) below:

La_{(1-x-y)}CeₓTb_{y}PO₄ (II)

wherein x and y satisfy the following conditions:
0.4≦x≦0.7;
0.13≦y≦0.17.

More particularly, the phosphate of lanthanum, cerium and terbium of the shell may correspond to the general formula (II) in which x satisfies the condition 0.43≦x≦0.60 and more particularly 0.45≦x≦0.60.

More particularly too, the phosphate of lanthanum, cerium and terbium of the shell may correspond to the general formula (II) in which y satisfies the condition 0.13≦y≦0.16 and more particularly 0.15≦y≦0.16.

According to a variant of this second embodiment, x and y simultaneously satisfy the two particular conditions given above.

The core of the precursor according to this second embodiment may have an average diameter between, especially, 1 and 5.5 μm, more particularly between 2 and 4.5 μm.

The other features of the precursor according to this second embodiment are identical to that of the precursor according to the first embodiment. This is especially understood here to mean the nature and the composition of the mineral core, the thickness and the homogeneity of the layer. That which was described in the first embodiment therefore applies likewise here.

The precursor of this second embodiment may be prepared by the method described in WO 2008/012266.

The phosphors obtained from the precursor of this second embodiment have the advantage of simultaneously possessing a fine particle size and completely satisfactory luminescence properties.

### THE PRECURSOR ACCORDING TO A THIRD EMBODIMENT

Another particular embodiment of precursors that can be used for the preparation of the phosphors of the invention will be described below. These precursors have a mineral core and a shell based on a mixed phosphate of at least one rare earth (Ln), Ln denoting cerium, cerium in combination with terbium, or lanthanum in combination with cerium and/or terbium, and they contain potassium or sodium in a content of at most 7000 ppm. These precursors have the advantage of being able to be obtained by preparation methods that use few/little or no nitrates or ammonia and do so without a negative impact on the luminescence properties of the products obtained.

For the remainder of the description of this third particular embodiment, the expression “sodium precursor” will denote the precursor containing sodium and the expression “potassium precursor” will denote the precursor containing potassium.

It is also specified here and for the whole of the description of this embodiment that the content of sodium or of potassium is measured according to two techniques. The first is the X-ray fluorescence technique and it makes it possible to measure sodium or potassium contents that are at least 100 ppm approximately. This technique will be used more particularly for the precursors for which sodium or potassium contents are the highest. The second technique is the ICP (inductively coupled plasma)-AES (atomic emission spectroscopy) or ICP-OES (optical emission spectroscopy) technique. This technique will be used more particularly here for the precursors for which the sodium or potassium contents are the lowest, especially for contents of less than approximately 100 ppm.

The phosphate of the shell may have three types of crystal structure depending on the variants of this embodiment of the invention. These crystal structures may be determined by XRD.

According to a first variant, the phosphate of the shell may firstly have a monazite crystal structure.

According to a second variant, the phosphate may have a rhabdophane structure.

Finally, according to a third variant, the phosphate of the shell may have a mixed rhabdophane/monazite structure.

The monazite structure corresponds to the precursors which, after their preparation, have undergone a heat treatment at a temperature generally of at least 600° C. in the case of sodium precursors and of at least 650° C. in the case of potassium precursors.

The rhabdophane structure corresponds to the precursors which, after their preparation, have either not undergone a heat treatment or have undergone a heat treatment at a temperature generally not exceeding 400° C.

The phosphate of the shell for the precursors that have not undergone a heat treatment is generally hydrated. However, simple drying operations, carried out for example between 60° C. and 100° C., are sufficient to remove most of this residual water and to result in a substantially anhydrous rare-earth phosphate, the minor amounts of water remaining being removed by calcination carried out at higher temperatures, above about 400° C.

The mixed rhabdophane/monazite structure corresponds to the precursors which have undergone a heat treatment at a temperature of at least 400° C., possibly up to a temperature of below 600° C., which may be between 400° C. and 500° C.

According to a preferred variant, the phosphates of the shell are pure phases, that is to say the XRD diffractograms reveal just a single and unique monazite phase or rhabdophane phase depending on the variant. However, the phosphate may also not be a pure phase, and in this case the XRD diffractogram of the products shows the presence of very minor residual phases.

One important feature of the precursors of this third embodiment is the presence of sodium or potassium.

According to preferred variants of this third embodiment of the invention, the sodium or potassium is present mostly (by this is meant at least 50% of the sodium or potassium) in the shell, preferably essentially (by this is meant approximately at least 80% of the sodium or potassium) in the shell or even entirely in the shell.

It may be thought that the sodium or potassium, when it is in the shell, is not present therein simply as a mixture with the other constituents of the phosphate of the shell but forms a chemical bond with one or more constituent chemical elements of the phosphate. The chemical nature of this bond may be demonstrated by the fact that simple washing, with pure water at atmospheric pressure, does not remove the sodium or potassium present in the phosphate of the shell.

As mentioned above, the sodium or potassium content is at most 7000 ppm, more particularly at most 6000 ppm and even more particularly at most 5000 ppm in the particular case of sodium. This content is expressed, here and throughout the description of this third embodiment, as the mass of sodium or potassium element relative to the total mass of the precursor.

Even more particularly, this sodium or potassium content of the precursor may depend on the variants described above, i.e. on the crystal structure of the phosphate of the shell.

Thus, if the phosphate of the shell has a monazite structure, this content may more particularly be at most 4000 ppm and more particularly at most 3000 ppm in the case of potassium.

In the case of a phosphate of the shell having a rhabdophane or mixed rhabdophane/monazite structure, the sodium or potassium content may be higher than that in the preceding case. It may be even more particularly at most 5000 ppm.

The minimum sodium or potassium content is not critical. This may correspond to the minimum value detectable by the analysis technique used to measure the sodium content. However, generally this minimum content is at least 300 ppm whatever in particular the crystal structure of the phosphate of the shell.

This content may more particularly be at least 1000 ppm and may be even more particularly at least 1200 ppm.

According to one preferred embodiment, the sodium content may be between 1400 ppm and 2500 ppm and the potassium content between 3000 ppm and 4000 ppm.

According to a variant of this third particular embodiment of the invention, the precursor contains, as alkali metal element, only sodium or only potassium.

In this third particular embodiment, the phosphate of the shell may essentially comprise a product that corresponds to the general formula (III) below:

LaₓCe_{y}Tb_{z}PO₄ (III)

wherein the sum x+y+z is equal to 1 and x may more particularly be between 0.2 and 0.98 and even more particularly between 0.4 and 0.95.

Preferably z is at most 0.5 and z may be between 0.05 and 0.2 and more particularly between 0.1 and 0.2.

If y and z are both different from 0, x may be between 0.2 and 0.7 and more particularly between 0.3 and 0.6.

If z is equal to 0, y may be more particularly between 0.02 and 0.5 and even more particularly between 0.05 and 0.25.

If x is equal to 0, z may more particularly be between 0.1 and 0.4.

The following more particular compositions may be mentioned purely as examples:
La_{0.44}Ce_{0.43}Tb_{0.13}PO₄
La_{0.57}Ce_{0.29}Tb_{0.14}PO₄
La_{0.94}Ce_{0.06}PO₄.

Here too, the other features of the precursor according to this third embodiment are identical to that of the precursor according to the first embodiment. Here too these are especially understood to mean the nature and the composition of the mineral core, the thickness and the homogeneity of the layer. That which was described in the first embodiment therefore applies likewise here.

### The Method for Preparing the Precursor According to the Third Embodiment

The method for preparing the sodium precursor will be described below.

The method of preparing this precursor is characterized in that it comprises the following steps:
a first solution that contains chlorides of one or more rare earths (Ln) is introduced continuously into a second solution that contains particles of the mineral core and phosphate ions and has an initial pH of less than 2;
while introducing the first solution into the second, the pH of the medium thus obtained is maintained at a constant value of less than 2, thereby obtaining a precipitate, the operation of setting the pH of the second solution at less than 2 for the first step or the operation of maintaining the pH for the second step, or both these operations, being carried out at least partly using sodium hydroxide;
the precipitate thus obtained is recovered; and
   either, in the case of preparing a precursor in which the rare-earth phosphate of the shell has a monazite crystal structure, said phosphate is calcined at a temperature of at least 600° C.;
   or, in the case of preparing a precursor in which the rare-earth phosphate of the shell has a rhabdophane or mixed rhabdophane/monazite crystal structure, said phosphate is calcined, possibly; at a temperature below 600° C.; and
the product obtained is redispersed in hot water and then separated from the liquid medium.

The various steps of the method will now be detailed.

According to the invention, a rare-earth (Ln) phosphate is precipitated directly, at a maintained pH, by reacting a first solution containing chlorides of one or more rare earths (Ln), these elements then being present in the required proportions for obtaining the product having the desired composition, with a second solution containing phosphate ions and particles of the mineral core, these particles being maintained in the dispersed state in said solution.

A core is chosen in the form of particles having a particle size appropriate to that of the composition intended to be prepared. Thus, a core having an average diameter in particular between 1 and 10 μm and having a dispersion index of at most 0.7 or at most 0.6 may in particular be used. Preferably, the particles have an isotropic, advantageously substantially spherical, morphology.

According to a first important feature of the method, a certain order of introducing the reactants must be respected and, more precisely still, the solution of chlorides of the one or more rare earths must be introduced progressively and continually into the solution containing the phosphate ions.

According to a second important feature of the method according to the invention, the initial pH of the solution containing the phosphate ions must be less than 2 and preferably between 1 and 2.

According to a third feature, the pH of the precipitation medium must then be maintained at a pH value of less than 2 and preferably between 1 and 2.

The term “maintained pH” is understood to mean that the pH of the precipitation medium is maintained at a certain, constant or approximately constant, value by addition of a basic compound to the solution containing the phosphate ions, this addition being simultaneous with the introduction into said solution of the solution containing the rare-earth chlorides. The pH of the medium will thus vary by at most 0.5 pH units about the setpoint value set, and more preferably by at most 0.1 pH units about this value. The setpoint value set will advantageously correspond to the initial pH (less than 2) of the solution containing the phosphate ions.

The precipitation is preferably carried out in aqueous medium at a temperature which is not critical and is advantageously between room temperature (15° C.-25° C.) and 100° C. This precipitation takes place while the reaction medium is being stirred.

The concentrations of the rare-earth chlorides in the first solution may vary widely. Thus, the total rare-earth concentration may be between 0.01 mol/liter and 3 mol/liter.

Finally, it should be noted that the rare-earth chloride solution may further contain other metal salts, especially chlorides, such as for example salts of the promoter or stabilizer elements described above, i.e. boron and other rare earths.

The phosphate ions intended to react with the rare-earth chloride solution may be supplied by pure or dissolved compounds, such as for example phosphoric acid, alkali metal phosphates or phosphates of other metallic elements giving, with the anions associated with the rare earths, a soluble compound.

The phosphate ions are present in an amount such that, between the two solutions, there is a PO₄/Ln molar ratio of greater than 1 and advantageously between 1.1 and 3.

As emphasized earlier in the description, the solution containing the phosphate ions and the particles of the mineral core must have initially (i.e. before the rare-earth chloride solution starts to be introduced) a pH of less than 2 and preferably between 1 and 2. Therefore, if the solution used does not naturally have such a pH, this is brought to the desired suitable value either by addition of a basic compound or by addition of an acid (for example hydrochloric acid in the case of an initial solution having too high a pH).

Thereafter, as the solution containing the rare-earth chloride or chlorides is being introduced, the pH of the precipitation medium progressively decreases. Therefore, according to one of the essential features of the method according to the invention, for the purpose of maintaining the pH of the precipitation medium at the constant desired working value, which must be less than 2 and preferably between 1 and 2, a basic compound is introduced simultaneously into this medium.

According to another feature of the method of the invention, the basic compound used, either for bringing the initial pH of the second solution containing the phosphate ions to a value below 2 or for maintaining the pH during precipitation, is, at least partly, sodium hydroxide. The expression “at least partly” is understood to mean that it is possible to use a mixture of basic compounds, at least one of which is sodium hydroxide. The other basic compound may for example be ammonium hydroxide. According to a preferred embodiment, a basic compound which is just sodium hydroxide is used, and according to another even more preferable embodiment sodium hydroxide is used alone and for both the aforementioned operations, i.e. both for bringing the pH of the second solution to the suitable value and for maintaining the precipitation pH. In these two preferred embodiments, the discharge of nitrogenous products, which could arise from a basic compound such as ammonium hydroxide, is lessened or eliminated.

What is obtained directly after the precipitation step is a rare-earth (Ln) phosphate deposited as shell on the mineral core particles, possibly with other elements having been added. The overall concentration of rare earths in the final precipitation medium is then advantageously greater than 0.25 mol/liter.

After the precipitation, a maturation operation may optionally be carried out by maintaining the reaction medium obtained above at a temperature lying within the same temperature range as that within which the precipitation took place and for a time which may for example be between a quarter of an hour and one hour.

The precipitate may be recovered by any means known per se, in particular by simple filtration. Specifically, under the conditions of the method according to the invention, a compound comprising a filterable nongelatinous rare-earth phosphate is precipitated.

The product recovered is then washed, for example with water, and then dried.

The product may then be subjected to a calcination or heat treatment.

This calcination may be optionally carried out and at various temperatures depending on the structure of the phosphate intended to be obtained.

The duration of calcination is generally shorter the higher the temperature. Solely by way of example, this duration may be between 1 and 3 hours.

The heat treatment is generally carried out in air.

In general, the calcination temperature is at most about 400° C. in the case of a product in which the phosphate of the shell has a rhabdophane structure, this structure also being that of the uncalcined product resulting from the precipitation. In the case of the product in which the phosphate of the shell has a mixed rhabdophane/monazite structure, the calcination temperature is generally at least 400° C. and may be up to, but below, 600° C. It may be between 400° C. and 500° C.

To obtain a precursor in which the phosphate of the shell has a monazite structure, the calcination temperature is at least 600° C. and may be between about 700° C. and a temperature below 1000° C., more particularly at most about 900° C.

According to another important feature of the preparation method, the product after calcination or even precipitation in the case of no heat treatment is then redispersed in hot water.

This redispersing operation is carried out by introducing the solid product into the water with stirring. The suspension thus obtained is kept stirred for a period which may be between about 1 and 6 hours, more particularly between about 1 and 3 hours.

The temperature of the water may be at least 30° C., more particularly at least 60° C., and may be between about 30° C. and 90° C., preferably between 60° C. and 90° C., at atmospheric pressure. It is possible to carry out this operation under pressure, for example in an autoclave, at a temperature which may then be between 100° C. and 200° C., more particularly between 100° C. and 150° C.

In a final step, the solid is separated from the liquid medium by any means known per se, for example by simple filtration. The redispersing step may optionally be repeated, one or more times, under the conditions described above, possibly at a different temperature from that at which the first redispersing step was carried out.

The separated product may be washed, in particular with water, and may be dried.

The method of preparing the potassium precursor will be described below.

This method comprises the following steps:
a first solution that contains chlorides of one or more rare earths (Ln) is introduced continuously into a second solution that contains particles of the mineral core and phosphate ions and has an initial pH of less than 2;
while introducing the first solution into the second, the pH of the medium thus obtained is maintained at a constant value of less than 2, thereby obtaining a precipitate, the operation of setting the pH of the second solution at less than for the first step or the operation of maintaining the pH for the second step, or both these operations, being carried out at least partly using potassium hydroxide;
the precipitate thus obtained is recovered; and
either, in the case of preparing a precursor in which the rare-earth phosphate of the shell has a monazite crystal structure, said phosphate is calcined at a temperature of at least 650° C., more particularly between 700° C. and 900° C.;
or, in the case of preparing a precursor in which the rare-earth phosphate of the shell has a rhabdophane or mixed rhabdophane/monazite crystal structure, said phosphate is calcined, possibly, at a temperature below 650° C.; and
the product obtained is redispersed in hot water and then separated from the liquid medium.

As can be seen, this method is very similar to that which was described for the preparation of the sodium precursor, the differences being mainly in the calcination temperatures. Everything which was described above for the preparation of the sodium precursor therefore applies here for that of the potassium precursor, potassium hydroxide being used in place of sodium hydroxide.

### The Process for Preparing the Phosphor of the Invention

The process for preparing the phosphor of the invention comprises a heat treatment of the precursor as described according to the various embodiments above.

This heat treatment is carried out under a reducing atmosphere (H₂, N₂/H₂ or Ar/H₂ for example).

According to an essential feature of the invention, it is carried out in the presence of a flux, or fluxing agent, which is lithium tetraborate (Li₂B₄O₇). The fluxing agent is mixed with the precursor to be treated in an amount of tetraborate which is at most 0.2% by weight of tetraborate relative to the fluxing agent+precursor assembly. This amount may be more particularly between 0.1 and 0.2%.

The temperature of the treatment is between 1050° C. and 1150° C. The treatment time is between 2 and 4 hours, this time being understood to mean a whole time at the temperature given previously.

After treatment, the particles are advantageously washed, so as to obtain a phosphor that is as pure as possible and that is in a deagglomerated or slightly agglomerated state. In the latter case, it is possible to deagglomerate the phosphor by subjecting it to a deagglomeration treatment under mild conditions, for example using a ball mill.

The phosphor thus obtained is formed of particles having an average diameter between 1.5 and 15 microns, more particularly between 4 and 8 microns.

Furthermore, these particles usually have a very homogeneous particle size distribution with a dispersion index of less than 0.6, for example of less than 0.5.

It may be noted that the heat treatment according to the method of the invention induces a slight variation between the size of the particles of precursors and those of the phosphors. This variation is generally at most 20%, more particularly at most 10%. Therefore, it is not necessary to mill the phosphor in order to bring its average particle size back to the average particle size of the initial precursor. It is particularly advantageous in the case where it is desired to prepare fine phosphors, for example having an average particle diameter of less than 10μ.

The absence of milling and the implementation of a simple deagglomeration in the method of preparing phosphors makes it possible to obtain products that do not have surface defects, which helps to improve the luminescence properties of these products. The SEM micrographs of the products indeed show that their surface is substantially smooth. In particular, this has the effect of limiting the interaction of the products with mercury when the latter are used in mercury vapour lamps and therefore of constituting an advantage in the use thereof.

The fact that the surface of the phosphors of the invention is substantially smooth may also be demonstrated by the specific surface area measurement of these phosphors. Indeed, these phosphors, which therefore have a core-shell structure, possess a specific surface area which is substantially lower, for example by around 30%, than that of products which have not been prepared by the method of the invention.

A phosphor according to the invention, of given composition and particle size will have, compared to a phosphor of the same composition and of the same size, a better crystallinity and therefore superior luminescence properties. This improved crystallinity may be demonstrated when the intensity I1 of the XRD diffraction peak corresponding to the shell is compared to the intensity I2 of the peak corresponding to the core. Compared to a comparative product of the same composition but which has not been prepared by the method of the invention, the ratio I1/I2 is higher for the product according to the invention.

The phosphors of the invention have intense luminescence properties in the green for electro-magnetic excitations corresponding to the various absorption fields of the product.

Thus, the phosphors based on cerium and terbium of the invention may be used in lighting or display systems having an excitation source in the UV range (200-280 nm), for example around 254 nm. In particular, note will be made of mercury vapor trichromatic lamps, lamps for backlighting liquid crystal systems, in tubular or flat form (LCD Back Lighting).

The terbium-based phosphors of the invention are also good candidates as green phosphors for VUV (or “plasma”) excitation systems such as for example plasma screens and trichromatic lamps without mercury, especially xenon excitation lamps (tubular or flat).

The phosphors of the invention may also be used as green phosphors in light-emitting diode excitation devices. They may especially be used in systems that can be excited in the near W.

They may also be used in UV excitation marking systems.

The phosphors of the invention may be applied in the lamp and screen systems by well-known techniques, for example by screen printing, electrophoresis or sedimentation.

They may also be dispersed in organic matrices (for example, plastic matrices or matrices of polymers that are transparent under UV, etc.), mineral matrices (for example silica matrices) or mixed organo-mineral matrices.

The invention also relates, according to another aspect, to the luminescent devices of the aforementioned type, comprising the phosphors (L) of the invention as a source of green luminescence.

These devices may be UV excitation devices, especially trichromatic lamps, in particular mercury vapour trichromatic lamps, lamps for backlighting liquid crystal systems, plasma screens, xenon excitation lamps, light-emitting diode excitation devices and UV excitation marking systems.

Examples will now be given.

In the following examples, the products prepared are characterized in terms of particle size, morphology and composition by the following methods.

### Particle Size Measurements

The particle diameters were determined using a Coulter laser particle size analyzer (Malvern 2000) on a sample of particles dispersed in water and subjected to ultrasound (100 W) for 5 minutes.

### Electron Microscopy

SEM micrographs were obtained from a section (microtomy) of the particles using a high-resolution JEOL 2010 FEG SEM microscope. The spatial resolution of the instrument for the chemical composition measurements by EDS (energy dispersion spectroscopy) was <2 nm. The correlation of the observed morphologies and the measured chemical compositions made it possible to demonstrate the core-shell structure, and to measure the thickness of the shell on the micrographs.

The chemical composition measurements by EDS were carried out by X-ray diffraction analysis on micrographs produced by HAADF-STEM. The measurement corresponds to an average taken over at least two spectra. The spatial resolution for the composition is sufficient to distinguish the core and shell compositions.

### X-Ray Diffraction

The X-ray diffractograms were produced using the K_{α} line with copper as anticathode according to the Bragg-Brentano method. The resolution is chosen so as to be sufficient to separate the LaPO₄:Ce,Tb line from the LaPO₄ line, preferably this resolution was Δ(2θ)<0.02°.

### EXAMPLE 1

This example relates to the preparation of a core-shell precursor having a lanthanum phosphate core and a lanthanum cerium terbium phosphate shell.

### Step 1: Preparation of a Lanthanum Phosphate Core

Added over one hour to 500 ml of a phosphoric acid H₃PO₄ solution (1.725 mol/l) previously brought to pH 1.8 by addition of ammonium hydroxide, and heated to 60° C., were 500 ml of a lanthanum nitrate solution (1.5 mol/l). The pH during the precipitation was adjusted to 1.9 by addition of ammonium hydroxide.

At the end of the precipitation step, the reaction medium was again held for 1 h at 60° C. The precipitate was then easily recovered by filtration, washed with water, then dried at 60° C. in air. The powder obtained was then subjected to a heat treatment at 900° C. in air.

The product thus obtained, characterized by X-ray diffraction, was a lanthanum orthophosphate LaPO₄ of monazite structure. The particle size (D₅₀) was 5.0 μm, with a dispersion index of 0.4.

The powder was then calcined for 4 h at 1200° C. in air. A rare earth phosphate of monazite phase having a particle size (D₅₀) of 5.3 μm, with a dispersion index of 0.4, was then obtained. The product was then deagglomerated in a ball mill until an average particle size (D₅₀) of 4.3 μm was obtained. It has a specific surface area of 1 m²/g.

### Step 2: Synthesis of an LaPO₄—LaCeTbPO₄ Core-Shell Precursor

In a 1-liter beaker, a solution of rare earth nitrates (Solution A) was prepared as follows: 29.37 g of a 2.8M (d=1.678 g/l) solution of La(NO₃)₃, 20.84 g of a 2.88M (d=1.715 g/l) solution of Ce(NO₃)₃ and 12.38 g of a 2M (d=1.548 g/l) solution of Tb(NO₃)₃ and 462 ml of deionized water were mixed, making a total of 0.1 mol of rare earth nitrates, of composition (La_{0.49}Ce_{0.35}Tb_{0.16})(NO₃)₃.

Introduced into a 2-liter reactor were (Solution B) 340 ml of deionized water, to which 13.27 g of Normapur 85% H₃PO₄ (0.115 mol) and then 28% ammonium hydroxide NH₄OH were added, to attain a pH of 1.5. The solution was heated to 60° C. Next, added to the stock thus prepared, were 23.4 g of a lanthanum phosphate from step 1. The pH was adjusted to 1.5 with 28% NH₄OH. The previously prepared solution A was added with stirring to the mixture using a peristaltic pump at 10 ml/min, at temperature (60° C.) and with the pH adjusted to 1.5. The mixture obtained was matured for 1 h at 60° C. At the end of the maturing step, the solution had a milky white appearance. It was left to cool down to 30° C. and the product was drained. It was then filtered over sintered glass and washed with two volumes of water, then dried and calcined for 2 h at 900° C. in air.

A rare earth phosphate of monazite phase was then obtained having two monazite crystalline phases of separate compositions, namely LaPO₄ and (La,Ce,Tb)PO₄. The particle size (D₅₀) was 6.3 μm, with a dispersion index of 0.5.

The product had, by SEM observation on a section of product, a typical morphology of core-shell type. The product had an amount of terbium of 66 g of Tb₄O₇ per kg of phosphor.

### COMPARATIVE EXAMPLE 2

This example relates to the preparation of a core-shell phosphor which is not obtained by the method of the invention.

The precursor powder obtained at the end of step 2 of example 1 was calcined for 2 h in an Ar/H₂ (5% hydrogen) atmosphere at a temperature of 1100° C. At the end of this step, a core-shell phosphor was obtained. The particle size (D₅₀) was 6.8 μm, with a dispersion index of 0.38.

The phosphor obtained had an XRD diagram characteristic of a core-shell compound. The position of the peaks indicates that the composition of the shell is identical to the composition of the shell of the precursor resulting from step 2 of example 1.

It has a surface morphology similar to that of the precursor, with a specific surface area of 0.54 m²/g.

FIG. 2 is an SEM micrograph of particles of the phosphor which shows that their surface is not smooth.

### COMPARATIVE EXAMPLE 3

This example relates to obtaining a core-shell phosphor which is not obtained by the method of the invention.

The precursor obtained at the end of step 2 of example 1 was calcined at 1025° C. for 3 h under an Ar/H₂ (5% hydrogen) reducing atmosphere in the presence of 0.5% by weight of lithium borate Li₂B₄O₇ relative to the amount of precursor.

The particles have a smooth surface and a D₅₀ of 6.8 μm. The specific surface area measured is 0.26 m²/g.

### EXAMPLE 4

This example relates to obtaining a core-shell phosphor according to the invention.

The precursor obtained at the end of step 2 of example was calcined at 1100° C. for 4 h in an Ar/H₂ (5% hydrogen) reducing atmosphere in the presence of 0.1% by weight of lithium borate Li₂B₄O₇ relative to the amount of precursor.

The phosphor obtained has an XRD diagram characteristic of a core-shell compound.

The particles have a smooth surface and a D₅₀ of 6.8 μm. The specific surface area measured is 0.28 m²/g. A thickness of the shell of 500 nm on average was measured by TEM.

FIG. 3 is an SEM micrograph of particles of the phosphor which shows that their surface is smooth.

### COMPARATIVE EXAMPLE 5

This example relates to obtaining a core-shell phosphor which is not obtained by the method of the invention.

The precursor obtained at the end of step 2 of example is calcined at 1100° C. for 2 h in an Ar/H₂ (5% hydrogen) reducing atmosphere in the presence of 1% by weight of lithium borate Li₂B₄O₇ relative to the amount of core-shell precursor.

The phosphor obtained has an XRD diagram characteristic of a core-shell compound.

The particles have a surface that is smooth and they have a D₅₀ of 8.3 μm. The specific surface area measured is 0.24 m²/g.

In the table below, the various characteristics of the products of the examples are given.

| | | | Crystallinity |
|---|---|---|---|
| Example | PL | D50 (σ/m) | index |
| 2 comparative | 100 | 6.8 (0.38) | 1.1 |
| 3 comparative | 98 | 6.8 (0.43) | 1.8 |
| 4 | 102 | 6.8 (0.39) | 1.7 |
| 5 comparative | 95 | 8.3 (0.5) | 2.6 |

PL denotes the photoluminescence yield. In the table, the yield of the phosphor from example 2 is taken as a reference, with a value of 100. The measurements were made by integration of the emission spectrum between 450 nm and 700 nm, under excitation at 254 nm, measured on a Jobin-Yvon spectrophotometer.

The crystallinity index of the shell is measured by the crystallinity ratio I1/I2, I2 being the intensity of the diffraction peaks of the core (at the maximum peak between 28.4 and 28.6 degrees) and I1 that of the peak of the shell (at the maximum peak between 28.6 and 29 degrees). A well-crystallized shell is characterized by a high crystallinity index.

Found in FIG. 1 are the diffractograms for the phosphors from examples 2 to 5.

The data from the table clearly reveals the advantageous properties of the product of the invention and also the advantages provided by its method of preparation when taking, as a point of comparison, the product from example 2 which was obtained by a method from the prior art.

Thus, the product from example 4 according to the invention has, compared to that of example 2, a better crystallinity with an improved photoluminescence yield and a particle size identical to that of the product from example 2 which expresses an absence of sintering during the calcination.

The product from example 3 was not obtained by a method having all of the features of the method of the invention. This product is well crystallized but it has a loss of photoluminescence yield compared to the comparative product.

The product from example 5, which was also not obtained by a method having all of the features of the method of the invention, also has a drop of the photoluminescence yield and above all a significant increase in the particle size and also in the dispersion index, a consequence of sintering of the particles during the calcination of the precursor.

1. A phosphor comprising particles comprised of a mineral core and a shell that comprises a mixed phosphate of lanthanum and/or cerium, optionally doped with terbium, homogeneously covering the mineral core over a thickness greater than or equal to 300 nm, wherein the phosphor is obtained by a method wherein a precursor comprising the particles having an average diameter from 1.5 microns to 15 microns is heat-treated under a reducing atmosphere, the heat treatment taking place in the presence, as fluxing agent, of lithium tetraborate (Li₂B₄O₇) in an amount by weight of at most 0.2%, at a temperature from 1050° C. to 1150° C. and over a duration of 2 hours to 4 hours.

2. The phosphor as described in claim 1, wherein the phosphor is obtained by the aforementioned method wherein the shell of the precursor particles covers the mineral core over a thickness of from 0.3 micron to 1 micron.

3. The phosphor as described in claim 1, wherein the phosphor is obtained by the aforementioned process wherein the mineral core of the precursor particles is comprised of a phosphate or a mineral oxide.

4. The phosphor as described in claim 1, wherein the phosphor is obtained by the aforementioned process wherein the mixed phosphate of the shell of the precursor particles corresponds to the general formula (I) below:
La_{(1-x-y)}CeₓTb_{y}PO₄ (I),
wherein:
x is from 0 to 0.95 inclusive;
y is from 0.05 to 0.3 inclusive; and
the sum (x+y) is less than or equal to 1.

5. The phosphor as described in claim 1, wherein the phosphor is obtained by the aforementioned process wherein the mixed phosphate of the shell of the precursor particles corresponds to the general formula (Ia) below:
La_{(1-x-y)}CeₓTb_{y}PO₄ (Ia),
wherein:
x is from 0.1 to 0.5 inclusive;
y is between 0.1 to 0.3 inclusive; and
the sum (x+y) is between 0.4 to 0.6.

6. The phosphor as described in claim 1, wherein the phosphor is obtained by the aforementioned process wherein the mixed phosphate of the shell of the precursor particles corresponds to the general formula (Ib) below:
La_{(1-y)}Tb_{y}PO₄ (Ib),
wherein:
y is from 0.05 to 0.3 inclusive;
or else to the formula (Ic) below:
La_{(1-y)}Ce_{y}PO₄ (Ic),
wherein:
y is from 0.01 to 0.3 inclusive.

7. The phosphor as described in claim 1, wherein the phosphor is obtained by the aforementioned method wherein the precursor particles have an average diameter from 3 μm to 6 μm and in that the phosphate of lanthanum, cerium and terbium corresponds to the general formula (II) below:
La_{(1-x-y)}CeₓTb_{y}PO₄ (II),
wherein x and y satisfy the following conditions:
0.4≦x≦0.7; and
0.13≦y≦0.17.

8. The phosphor as described in claim 1, wherein the phosphor is obtained by the aforementioned method wherein the shell of the precursor is based on a mixed phosphate of at least one rare earth (Ln), Ln denoting cerium, cerium in combination with terbium, or lanthanum in combination with cerium and/or terbium, the precursor comprising potassium or sodium in a content of at most 7000 ppm.

9. The phosphor as described in claim 1, wherein the phosphor is formed of particles having an average diameter of from 1.5 microns to 15 microns, and a dispersion index of less than 0.6.

10. A method of preparing a phosphor as described in claim 1, wherein the method comprises heat-treating a precursor comprising particles having an average diameter from 1.5 microns and 15 microns, these particles comprising a mineral core and a shell based on a mixed phosphate of lanthanum and/or cerium, optionally doped with terbium, homogeneously covering the mineral core over a thickness greater than or equal to 300 nm, the heat treatment taking place in the presence, as fluxing agent, of lithium tetraborate (Li₂B₄O₇) in an amount by weight of at most 0.2%, at a temperature of 1100° C. to 1150° C. and over a duration of from 2 hours to 4 hours.

11. The method as described in claim 10, wherein the phosphor is used in a UV excitation device, selected from the group consisting of a trichromatic lamp.

12. A luminescent device comprising a phosphor as described in claim 1, wherein the phosphor is a source of green luminescence.

13. The luminescent device as described in claim 12, wherein the luminescent device is a UV excitation device for trichromatic lamps.

14. The phosphor as described in claim 2, wherein the shell of the precursor particles covers the mineral core over a thickness of from 0.5 micron to 0.8 micron.

15. The phosphor as described in claim 3, wherein the mineral core of the precursor particles is comprised of a rare earth phosphate or an aluminum oxide.

16. The phosphor as described in claim 9, wherein the phosphor is formed of particles having an average diameter of 4 microns to 8 microns.

17. The method as described in claim 11, wherein the trichromatic lamp is selected from the group consisting of a mercury vapor trichromatic lamp, a lamp for the backlighting of liquid-crystal systems, a plasma screen, a xenon excitation lamp, a light-emitting diode excitation device and a UV excitation marking system.

18. The luminescent device as descried in claim 13, wherein the trichromatic lamp is selected from the group consisting of a mercury vapor trichromatic lamp, a lamp for the backlighting of liquid-crystal systems, a plasma screen, a xenon excitation lamp, a light-emitting diode excitation device and a UV excitation marking system.
